(19) United States
(12) Patent Application Publication
(10) Pub. No.: US 2026/0328795 A1
(43) Pub. Date: Oct. 22, 2026

(54) LIQUID MANAGEMENT DEVICE AND DISPENSING DEVICE

(71) Applicant: SHIMADZU CORPORATION, Kyoto-shi (JP)

(72) Inventors: Tetsuro FURUTA, Kyoto-shi (JP); Kota NAKAKITA, Kyoto-shi (JP); Yudai FUJIWARA, Kyoto-shi (JP); Tatsuya IWAMA, Kyoto-shi (JP); Nobuhiro HANAFUSA, Kyoto-shi (JP)

(21) Appl. No.: 19/655,154

(22) Filed: Apr. 22, 2026

(30) Foreign Application Priority Data
Apr. 22, 2025 (JP) 2025-070882

(51) Int. Cl. G01N 35/10; G01N 35/00

(52) U.S. Cl. CPC G01N 35/1011; G01N 35/00584; G01N 2035/1025; G01N 2035/103

(57) ABSTRACT

A liquid management device (5) included in a dispensing device (1) comprises: a placement unit (11) on which a liquid container is placed; a weight sensor (12) that measures a weight of the placement unit; a weight measurement value acquisition unit (21) that continuously acquires a measurement value of the weight sensor; and a zero-point correction execution unit (22) that executes zero-point correction of the weight sensor based on a plurality of measurement values acquired by the weight measurement value acquisition unit between a first time point that is a first predetermined time prior to a load-exceeding measurement value acquisition time point, which is a time point at which the measurement value acquired by the weight measurement value acquisition unit exceeded a predetermined threshold, and a second time point that is a second predetermined time prior to the first time point.

### TECHNICAL FIELD

The present invention relates to a liquid management device used in a dispensing device that dispenses liquid, and a dispensing device equipped with the liquid management device.

### BACKGROUND ART

In the treatment of infectious diseases, it is important to identify the type of bacteria causing the infection, and bacterial tests are conducted to identify the type of bacteria contained in blood collected from a patient with an infectious disease. For example, Patent Document 1 describes culturing blood to proliferate bacteria therein (blood culture specimen) and analyzing the specimen by mass spectrometry (MALDI-MS) using Matrix-Assisted Laser Desorption/Ionization (MALDI) to identify the bacterial species. When analyzing a blood culture specimen by MALDI-MS, a pretreatment is performed in which a hemolytic reagent is added to the blood culture specimen to lyse blood cells.

A pretreatment device is usually used for such pretreatment. The pretreatment device is equipped with a dispensing device, and the dispensing device executes a dispensing operation of collecting a predetermined amount of reagent from a reagent container and injecting it into a specimen container. As an example of such a dispensing device, Patent Document 2 describes a device having a specimen container holding unit and a reagent container holding unit that hold a specimen container and a reagent container respectively, a nozzle mechanism that aspirates a reagent from the reagent container through a nozzle and discharges it into the specimen container, and a nozzle moving mechanism that moves the nozzle between the reagent container and the specimen container.

In order to aspirate the reagent in the reagent container with the nozzle, a sufficient amount of reagent needs to be stored in the container. Therefore, a weight sensor is provided in the reagent container holding unit, and when the weight of the reagent container held in the reagent container holding unit falls to or below a predetermined value, a notification is issued. Upon receiving this notification, the user takes out the reagent container from the reagent container holding unit, replenishes the reagent, and then returns the reagent container to the reagent container holding unit.

### CITATION LIST

### Patent Literature

[Patent Document 1] JP 2024-104883 A
[Patent Document 2] JP 2014-235076 A

### SUMMARY OF INVENTION

### Technical Problem

In the above-mentioned dispensing device, zero-point correction of the weight sensor is performed when returning the reagent container to the reagent container holding unit. Thereby, the remaining amount of the reagent can be accurately measured. The zero-point correction of the weight sensor is executed by the user performing a predetermined operation. Therefore, if the user forgets the operation for zero-point correction, the pretreatment may be resumed without the zero-point correction of the weight sensor being performed, and there is a possibility that the weight of the reagent container cannot be measured accurately.

The problem to be solved by the present invention is to enable reliable execution of zero-point correction of a weight sensor in a liquid management device used in a dispensing device equipped with the weight sensor for measuring the weight of a liquid container in which a liquid to be dispensed is stored.

### Solution to Problem

A liquid management device according to the present invention made to solve the above problem comprises:
a placement unit on which a liquid container is placed;
a weight sensor that measures a weight of the placement unit;
a weight measurement value acquisition unit that continuously acquires a measurement value of the weight sensor; and
a zero-point correction execution unit that executes zero-point correction of the weight sensor based on a plurality of measurement values acquired by the weight measurement value acquisition unit between a first time point that is a first predetermined time prior to a load-exceeding measurement value acquisition time point, which is a time point at which the measurement value acquired by the weight measurement value acquisition unit exceeded a predetermined threshold, and a second time point that is a second predetermined time prior to the first time point.

### Advantageous Effects of Invention

In the liquid management device according to the present invention, the measurement value of the weight sensor acquired in the weight measurement value acquisition unit rises due to the liquid container being placed on the placement unit, and based on the load-exceeding measurement value acquisition time point, which is the time point at which the measurement value exceeded the predetermined threshold, the zero-point correction execution unit executes zero-point correction of the weight sensor based on a plurality of measurement values acquired between the first time point and the second time point which are prior thereto. Further, measurement values acquired between the first time point and the load-exceeding measurement value acquisition time point are excluded from the measurement values used for zero-point correction. The first predetermined time corresponds to a period during which the placement unit is in an unstable state from when the user starts the operation of placing the liquid container on the placement unit until the placement operation is completed. By not using the measurement values of the weight sensor measured during such a period for the zero-point correction processing, the zero-point correction of the weight sensor can be executed accurately. As described above, in the liquid management device according to the present invention, zero-point correction can be performed reliably and accurately without operation by the user, so there is no occurrence of measuring the weight of the liquid container in a state where the zero point is shifted.

### BRIEF DESCRIPTION OF DRAWINGS

FIG. 1 is a schematic configuration diagram showing a first embodiment of a dispensing device according to the present invention.

FIG. 2 is a flowchart showing the operation of zero-point correction in the dispensing device of the first embodiment.

FIG. 3 is a diagram showing a threshold, a load-exceeding measurement value acquisition time point, a first time, a second time, and a zero-point correction value on a graph showing fluctuations in measurement values during zero-point correction.

FIG. 4 is a schematic configuration diagram showing a second embodiment of the dispensing device according to the present invention.

FIG. 5 is a schematic configuration diagram showing a pipette tip tip height detection mechanism in the second embodiment of the dispensing device according to the present invention.

FIG. 6 is a diagram showing the operation of the pipette tip tip height detection mechanism.

FIG. 7 is a diagram showing differences in the height of the lower end of the pipette tip caused by differences in the inner diameter of the attached portion of the pipette tip.

### DESCRIPTION OF EMBODIMENTS

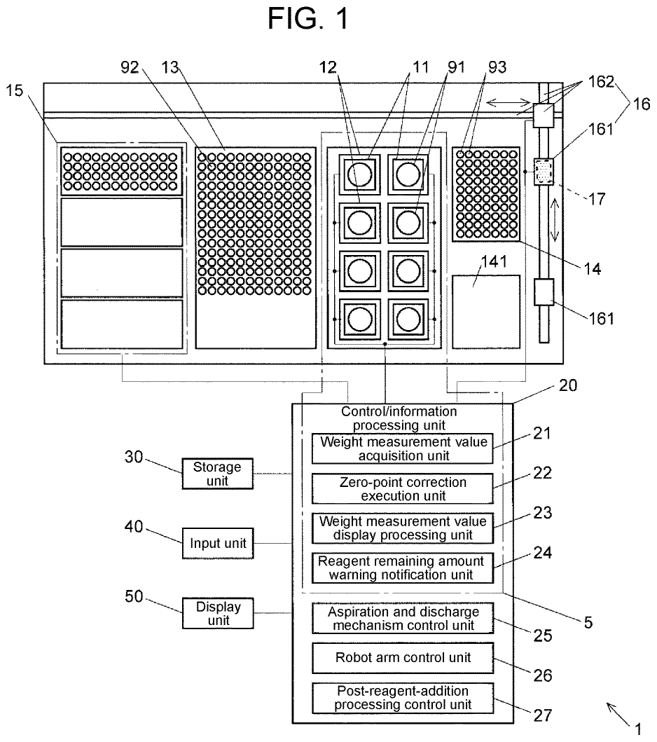

Embodiments of the dispensing device according to the present invention will be described using FIGS. 1 to 7.

### (1) First Embodiment

(1-1) Configuration of Liquid Management Device and Dispensing Device Equipped with Same of First Embodiment

FIG. 1 schematically shows the configuration of a liquid management device 5 of the present embodiment and a dispensing device 1 equipped with the same. This dispensing device 1 has placement units 11, weight sensors 12, a specimen container holding unit 13, an unused pipette tip holding unit 14, a used pipette tip storage container 141, a post-reagent-addition specimen processing unit 15, a robot arm 16, a liquid reagent aspiration and discharge mechanism 17, a control/information processing unit 20, a storage unit 30, an input unit 40, a display unit 50, and the like. The liquid management device 5 is constituted by the placement units 11 and weight sensors 12 among these components of the dispensing device 1, and a part of the control/information processing unit 20 (described later).

One liquid container 91, which is a container for accommodating a liquid described later, is placed on the placement unit 11. Although an example in which eight placement units 11 are provided is shown in FIG. 1, the number of placement units 11 is not limited to this example.

The weight sensor 12 is a sensor for measuring the weight of the placement unit 11, and one weight sensor 12 is provided for each placement unit 11. Each weight sensor 12 measures the weight of the placement unit 11 itself in a state where the liquid container 91 is not placed on the placement unit 11, and measures the combined weight of the placement unit 11 and the liquid container 91 in a state where the liquid container 91 is placed on the placement unit 11. A known sensor such as a load cell or a capacitance type sensor can be used for the weight sensor 12. Further, each weight sensor 12 has a function of transmitting a measurement value of weight and a unique identification code (information for distinguishing from other weight sensors 12) to the control/information processing unit 20. The measurement values of weight are transmitted continuously at predetermined time intervals.

The specimen container holding unit 13 holds a large number (e.g., 192) of specimen containers 92, which are containers for accommodating specimens subject to testing/analysis such as bacterial tests. The liquid accommodated in the aforementioned liquid container 91 is a reagent to be added to the specimen as a pretreatment for analysis. Although FIG. 1 shows an example in which a large number of specimen containers 92 each accommodating one specimen are held, one or a plurality of microplates having a large number (e.g., 192) of wells may be held as the specimen containers 92.

The unused pipette tip holding unit 14 holds a large number of unused pipette tips 93. The pipette tip 93 is a cylindrical member whose inner diameter near the lower end, which becomes the lower side during use, is narrowed. By inserting a probe of the liquid reagent aspiration and discharge mechanism 17 into the upper end during use, the pipette tip 93 is attached to the liquid reagent aspiration and discharge mechanism 17, and liquid is aspirated/discharged from the lower end. In the unused pipette tip holding unit 14, the pipette tips 93 are held with their upper ends facing upward.

The used pipette tip storage container 141 is a container for accommodating used pipette tips 93 removed from the liquid reagent aspiration and discharge mechanism 17. This used pipette tip storage container 141 can be removed from the dispensing device 1 when discarding the accommodated used pipette tips 93.

The post-reagent-addition specimen processing unit 15 performs processing such as shaking and centrifugation on the specimen to which the reagent has been added. Since the post-reagent-addition specimen processing unit 15 is not an essential element of the present invention, a detailed description thereof is omitted.

The robot arm 16 is provided above the placement units 11, weight sensors 12, specimen container holding unit 13, unused pipette tip holding unit 14, used pipette tip storage container 141, and post-reagent-addition specimen processing unit 15. The robot arm 16 has a gripping unit 161 that grips the specimen container 92, the liquid reagent aspiration and discharge mechanism 17, or the like, a planar movement mechanism 162 that moves the gripping unit 161 two-dimensionally, and an elevating mechanism (not shown) that moves the gripping unit 161 up and down. In the example shown in FIG. 1, two gripping units 161 are provided: one that constantly grips the liquid reagent aspiration and discharge mechanism 17, and one that grips the specimen container 92 when moving the specimen container 92. Instead, only one gripping unit 161 may be provided, and configured to grip the liquid reagent aspiration and discharge mechanism 17 when performing aspiration and discharge of the liquid reagent, and grip the specimen container 92 when moving the specimen container 92. The planar movement mechanism 162 can use a combination of a linear first rail provided along a direction for moving the gripping unit 161 linearly, a second rail provided along a direction for moving the first rail perpendicularly thereto within a plane, and a drive source for moving the gripping unit 161 and the first rail.

The liquid reagent aspiration and discharge mechanism 17 has a probe to which the pipette tip 93 is attached, and a gas aspiration and discharge device that aspirates gas from the probe and discharges gas to the probe. The liquid reagent aspiration and discharge mechanism 17 aspirates liquid from the tip of the pipette tip 93 into the pipette tip 93 by aspirating an amount of gas smaller than the volume inside the pipette tip 93 in a state where the pipette tip 93 is attached to the probe. Further, the liquid reagent aspiration and discharge mechanism 17 discharges the liquid in the pipette tip 93 by discharging gas to the pipette tip 93 in which the liquid has been aspirated.

The control/information processing unit 20 controls each part included in the dispensing device 1 and executes predetermined information processing, and is embodied by a CPU, a storage device such as a memory or a hard disk, other hardware, and software for operating such hardware. The control/information processing unit 20 has, as functional blocks, a weight measurement value acquisition unit 21, a zero-point correction execution unit 22, a weight measurement value display processing unit 23, a reagent remaining amount warning notification unit 24, an aspiration and discharge mechanism control unit 25, a robot arm control unit 26, and a post-reagent-addition processing control unit 27. Among these functional blocks, the weight measurement value acquisition unit 21, the zero-point correction execution unit 22, the weight measurement value display processing unit 23, and the reagent remaining amount warning notification unit 24 correspond to components of the liquid management device 5.

The weight measurement value acquisition unit 21 has a function of continuously acquiring measurement values of the weight of the placement unit 11 and identification codes transmitted from each weight sensor 12, and storing the measurement values in the storage unit 30 for each weight sensor identified by the identification code.

The zero-point correction execution unit 22 has a function of executing zero-point correction of the weight sensor 12 when the liquid container 91 is placed on the placement unit 11. Specific data processing when executing zero-point correction will be described later.

The weight measurement value display processing unit 23 has a function of executing processing for displaying the measurement values of weight acquired from each placement unit 11 by the weight measurement value acquisition unit 21 on the display unit 50. The measurement values of weight are displayed continuously in time not only when executing the zero-point correction which is a feature of the present invention, but also in the process of repeatedly executing the processing of dispensing the liquid reagent from the liquid container 91.

Further, the reagent remaining amount warning notification unit 24 executes processing of emitting a warning sound and displaying a warning on the display unit 50 when the measurement value of weight acquired by the weight measurement value acquisition unit 21 indicates that the remaining amount of reagent has decreased to a level requiring replenishment of the reagent due to repeated execution of dispensing processing.

Through the display of these weight measurement values and the warning sound/warning display, the user can become aware of the timing for replenishing the liquid reagent in the liquid container 91.

The aspiration and discharge mechanism control unit 25 controls the operation of the liquid reagent aspiration and discharge mechanism 17, the robot arm control unit 26 controls the operation of the robot arm 16, and the post-reagent-addition processing control unit 27 controls the operation of the post-reagent-addition specimen processing unit 15, respectively.

The storage unit 30 is a storage medium that stores the measurement values for each weight sensor acquired by the weight measurement value acquisition unit 21 as described above. A memory, a hard disk, an SSD (Solid State Drive), or the like included in a computer can be used for the storage unit 30.

The input unit 40 is a device for the user to input predetermined information. A keyboard, mouse, touch panel, or the like can be used for the input unit 40. The display unit 50 is a display on which the above-mentioned weight measurement results and other information regarding the operation of the dispensing device 1 are displayed.

(1-2) Operation of Liquid Management Device and Dispensing Device Equipped with Same of First Embodiment

The operations of the liquid management device 5 of the first embodiment and the dispensing device 1 equipped with the same will be described. In the following, the dispensing operation, that is, the operation of dispensing the liquid reagent from the liquid container 91 and supplying it to the specimen in the specimen container 92, will be described briefly since it is similar to that of a normal dispensing device, and the description will focus on the operation of zero-point correction of the weight sensor when the liquid reagent is replenished in the liquid container 91.

### (1-2-1) Dispensing Operation

Before starting the operation of the dispensing device 1, the user places the liquid container 91 storing the liquid reagent on the placement unit 11, causes the specimen container holding unit 13 to hold the specimen container 92 containing the specimen, and causes the unused pipette tip holding unit 14 to hold unused pipette tips. Then, when the user performs a predetermined setting operation using the input unit 40 and performs a start operation, the operation of the dispensing device 1 starts.

First, the robot arm 16 moves the liquid reagent aspiration and discharge mechanism 17 (the gripping unit 161 gripping it) onto the unused pipette tip holding unit 14 and then lowers it, thereby attaching an unused pipette tip 93 to the liquid reagent aspiration and discharge mechanism 17. Next, after raising the liquid reagent aspiration and discharge mechanism 17, the robot arm 16 moves it onto the liquid container 91 placed on one of the plurality of placement units 11 and then lowers it, thereby immersing the lower end of the pipette tip 93 in the liquid in the liquid container 91. In this state, the liquid reagent aspiration and discharge mechanism 17 aspirates a predetermined amount of liquid. Next, after raising the liquid reagent aspiration and discharge mechanism 17, the robot arm 16 moves it onto one of the plurality of specimen containers 92 held in the specimen container holding unit 13 and then lowers it, thereby inserting the lower end of the pipette tip 93 into the specimen container 92. In this state, the liquid reagent aspiration and discharge mechanism 17 discharges the liquid in the pipette tip 93. Thereafter, the robot arm 16 raises the liquid reagent aspiration and discharge mechanism 17, moves it onto the used pipette tip storage container 141, and then removes the pipette tip 93 attached to the liquid reagent aspiration and discharge mechanism 17 and stores it in the used pipette tip storage container 141.

Through the above processing, the processing of dispensing the liquid reagent to one specimen container 92 is completed. Thereafter, by repeatedly performing the above operations, dispensing of the liquid reagent is sequentially executed for the plurality of specimen containers 92.

Further, the robot arm 16 moves the gripping unit 161 that is not gripping the liquid reagent aspiration and discharge mechanism 17 onto the specimen container 92 to which the liquid reagent has been supplied, then lowers it, grips the specimen container 92, and moves it to the post-reagent-addition specimen processing unit 15. In the post-reagent-addition specimen processing unit 15, predetermined post-reagent-addition specimen processing is executed.

### (1-2-2) Operation of Zero-Point Correction of Weight Sensor

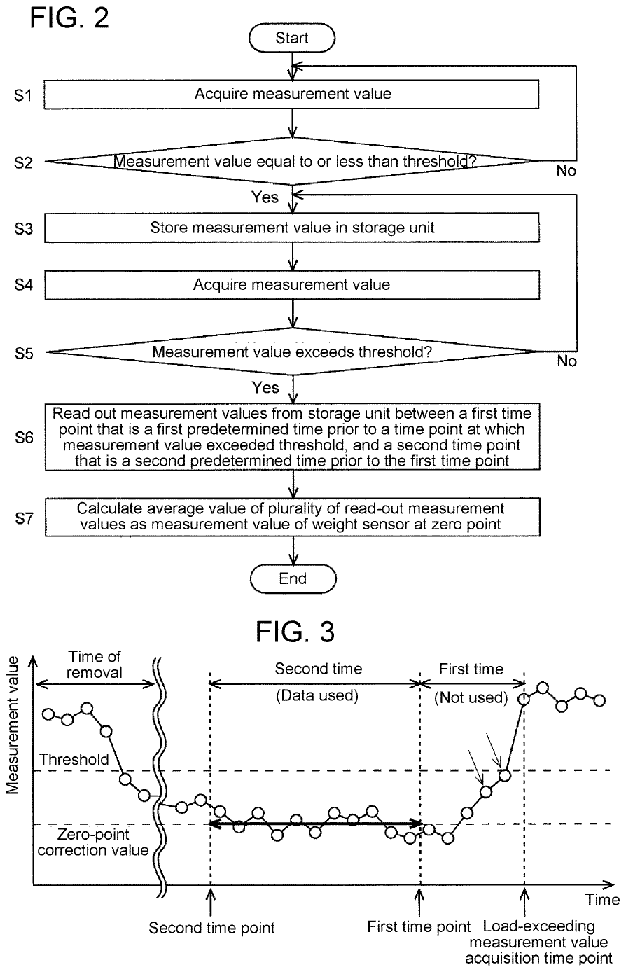

By repeatedly executing the dispensing processing described above, the liquid reagent in the liquid container 91 gradually decreases. Thereby, when the measurement value of weight acquired by the weight measurement value acquisition unit 21 falls below a predetermined value, the reagent remaining amount warning notification unit 24 notifies that the remaining amount of the liquid reagent in the liquid container 91 placed on a certain placement unit 11 has decreased. The user who receives this notification performs an operation of replenishing the liquid reagent in the liquid container 91. Note that the replenishment of the liquid reagent may be performed by injecting the liquid reagent into the liquid container 91 that has been used until then, or by replacing it with a new liquid container 91 in which the liquid reagent is already stored (in this specification, both are collectively referred to as “operation of replenishing the liquid reagent”). In conjunction with the operation of replenishing the liquid reagent performed by the user in this way, the liquid management device 5 executes the operation of zero-point correction for the weight sensor 12 of the placement unit 11 on which the liquid container 91 to be replenished is placed, as follows. Hereinafter, the operation of zero-point correction will be described with reference to the flowchart of FIG. 2 and the graph of FIG. 3.

First, when the user performs a predetermined operation using the input unit 40, the dispensing processing is stopped. When the dispensing processing stops, the operation of zero-point correction starts. When the user takes out the liquid container 91 to be replenished from the placement unit 11, the measurement value of the weight sensor 12 of the placement unit 11 decreases and falls below a predetermined threshold (“Time of removal” in FIG. 3). Here, the threshold is set to a value higher than the range assumed as the measurement value when the liquid container 91 is not placed after zero-point correction.

When the zero-point correction operation starts as described above, the weight measurement value acquisition unit 21 acquires the measurement value of the weight sensor 12 of the placement unit 11 on which the liquid container 91 to be replenished was placed (Step 1). While the acquired measurement value exceeds the threshold (No in Step 2), it means that the load of the liquid container 91 before replenishment is still applied to the weight sensor 12, so the obtained measurement value is not used for zero-point correction, and the process returns to Step 1 to continue acquiring the measurement value. Then, when the measurement value becomes equal to or less than the threshold (Yes in Step 2), the weight measurement value acquisition unit 21 stores the obtained measurement value in the storage unit 30 (Step 3).

After execution of Step 3, the weight measurement value acquisition unit 21 acquires a measurement value again (Step 4). When the acquired measurement value is equal to or less than the threshold (No in Step 5), the weight measurement value acquisition unit 21 returns to Step 3 to store the measurement value in the storage unit 30, and then acquires a measurement value again (Step 4). Thus, while the measurement value is equal to or less than the threshold, acquisition of the measurement value and storage in the storage unit 30 are repeated.

When the user places the liquid container 91 replenished with the liquid sample on the placement unit 11, the measurement value increases, but the measurement value of the weight sensor 12 becomes unstable during the period from when the user starts the operation of placing the liquid container 91 on the placement unit 11 until the placing operation is completed. In such an unstable time zone, the measurement value is higher than when the liquid container 91 is not placed, but falls below the threshold (measurement values indicated by arrows within “First time” in FIG. 3). If such unstable measurement values are used for the zero-point correction described later, an error occurs in the zero point. Therefore, in the present embodiment, while the measurement value is equal to or less than the threshold, the obtained measurement values (measurement values within the range described as “Not used” in FIG. 3) are not used for zero-point correction, and acquisition of measurement values is continued (No in Step 5). Then, when the measurement value exceeds the threshold (Yes in Step 5), the process proceeds to Step 6 to execute data processing for zero-point correction.

In Step 6, the zero-point correction execution unit 22 acquires, from the storage unit 30, measurement values (measurement values within the range described as “Data used” in FIG. 3) obtained between a first time point, which is a first predetermined time prior to the time point at which the measurement value exceeded the threshold (referred to as “load-exceeding measurement value acquisition time point”), and a second time point, which is a second predetermined time prior to the first time point. Further, the zero-point correction execution unit 22 calculates an average value of the acquired measurement values (Step 7). Note that a median value may be determined instead of the average value. Here, the first predetermined time is preset to a time sufficiently longer than the length of time during which the measurement value becomes unstable when placing the liquid container 91 on the placement unit 11. Also, the second predetermined time is set to a length of time capable of obtaining a sufficient number of measurement values to determine the average value. However, if the second predetermined time is too long, there is a risk of acquiring unstable measurement values immediately after the liquid container 91 before replenishment of the liquid reagent was taken out from the placement unit 11, so the second predetermined time is preset so that such measurement values are not included. The first predetermined time and the second predetermined time may be set by the user from a separately provided setting screen.

The average value (or median value) calculated as described above is obtained as the measurement value of the weight sensor at the zero point (a state where the liquid container 91 is not placed on the placement unit 11). A value obtained by subtracting the measurement value at the zero point from the measurement value of the weight sensor 12 when the liquid container 91 replenished with the liquid sample is placed is obtained as the weight of the liquid container 91 replenished with the liquid sample.

According to the liquid management device of the present embodiment, since zero-point correction is executed without the user performing a zero-point correction operation, it is possible to prevent inaccurate weight measurement of the liquid container 91 due to the user forgetting the zero-point correction operation. Furthermore, since measurement values obtained during the unstable time immediately after placement of the liquid container 91, from the first time point to the load-exceeding measurement value acquisition time point, are not used for zero-point correction, the zero-point correction can be performed accurately. For these reasons, the liquid management device of the present embodiment makes it possible to prevent measurement of the weight of the liquid container in a state where the zero point is shifted.

### (2) Second Embodiment

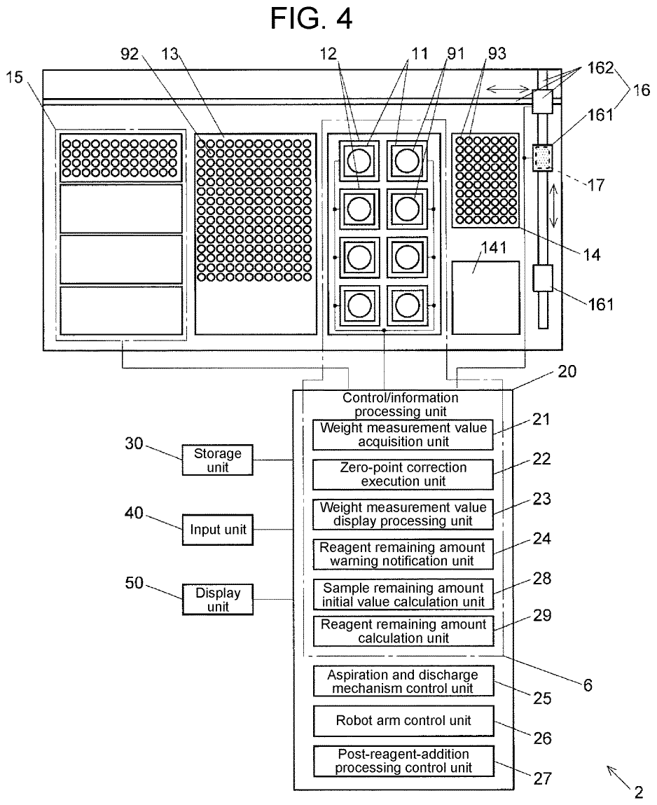

A liquid management device 6 of the second embodiment, in addition to each component of the liquid management device 6 [sic: should be 5] of the first embodiment, has a control/information processing unit 20 including a sample remaining amount initial value calculation unit 28 and a reagent remaining amount calculation unit 29 as functional blocks, as shown in FIG. 4. These sample remaining amount initial value calculation unit 28 and reagent remaining amount calculation unit 29 are provided to notify at a more appropriate timing by determining the remaining amount of the liquid reagent more directly, instead of based on the measurement value of the weight sensor 12, that is, the weight of the liquid container 91 in which the liquid reagent is stored (accurately, the weight obtained by adding the weight of the placement unit 11 thereto), when notifying that the remaining amount of the reagent has decreased in the reagent remaining amount warning notification unit 24. The configuration of the dispensing device 2 in the second embodiment is the same as the dispensing device 1 in the first embodiment, except that the liquid management device 5 in the first embodiment is replaced with the liquid management device 6 of the second embodiment.

The sample remaining amount initial value calculation unit 28 acquires a measurement value acquired by the weight measurement value acquisition unit 21 as a measurement initial value after the load-exceeding measurement value acquisition time point has passed during zero-point correction and before the first dispensing is executed from the liquid container 91 replenished with the liquid reagent. In addition, the sample remaining amount initial value calculation unit 28 acquires an empty container weight, which is information on the weight of an empty liquid container 91, from the storage unit 30. Then, the sample remaining amount initial value calculation unit 28 calculates a liquid weight initial value, which is an initial value of the weight of the liquid reagent accommodated in the liquid container 91 replenished with the liquid reagent, by subtracting the empty container weight from the measurement initial value. Note that the empty container weight is input by the user using the input unit 40 in advance, or stored in the storage unit 30 after measuring the empty liquid container 91 with the weight sensor.

The reagent remaining amount calculation unit 29 acquires a unit dispensing weight, which is the weight of liquid dispensed from the liquid container 91 by one dispensing, from the storage unit 30. The unit dispensing weight is input in advance using the input unit 40 when the user sets dispensing conditions. Further, the reagent remaining amount calculation unit 29 receives one signal every time the aspiration and discharge mechanism control unit executes control to aspirate the reagent solution once, and acquires dispensing count information, which is information on the number of times dispensing has been executed after correction from the liquid container 91 that was the target of zero-point correction, based on the number of times the signal is received. Then, the reagent remaining amount calculation unit 29 calculates the remaining amount of reagent in the liquid container 91 that was the target of zero-point correction by subtracting a value obtained by multiplying the unit dispensing weight and the dispensing count information from the liquid weight initial value.

When the remaining amount of liquid reagent calculated by the reagent remaining amount calculation unit 29 falls below a predetermined value, the reagent remaining amount warning notification unit 24 executes processing for issuing a warning. Subsequent operations of replenishing the liquid reagent by the user and the operation of zero-point correction are the same as in the case of the first embodiment.

According to the liquid management device 6 of the second embodiment, since the remaining amount of liquid in the liquid container 91 placed on the placement unit 11 can be grasped, the user can replenish the liquid in the liquid container 91 at an appropriate timing. Therefore, it is possible to prevent the liquid container 91 from becoming empty and making the dispensing processing impossible.

### (3) Third Embodiment

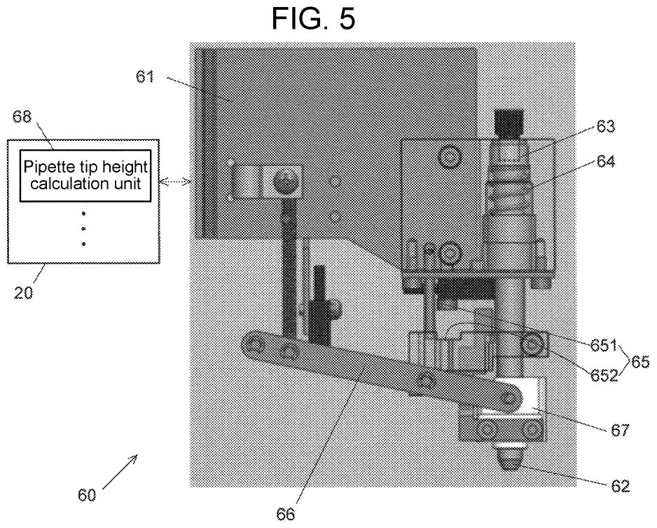

The dispensing device of the third embodiment is obtained by adding a pipette tip tip height detection mechanism 60 shown in FIG. 5 to the dispensing device 1 of the first embodiment or the dispensing device 2 of the second embodiment. Since components other than the pipette tip tip height detection mechanism 60 are the same as those of the first embodiment or the second embodiment including the liquid management device 5 or 6, detailed description thereof is omitted.

### (3-1) Configuration of Pipette Tip Tip Height Detection Mechanism 60

As shown in FIG. 5, the pipette tip tip height detection mechanism 60 has an elevating unit 61, a probe 62, a biasing member holding unit 63, a biasing member 64, a sensor 65, a movable bar 66, a probe fixture 67, and a pipette tip height calculation unit 68.

The elevating unit 61 is a member fixed to the elevating mechanism of the robot arm 16. The elevating unit 61 itself moves up and down by the operation of the elevating mechanism.

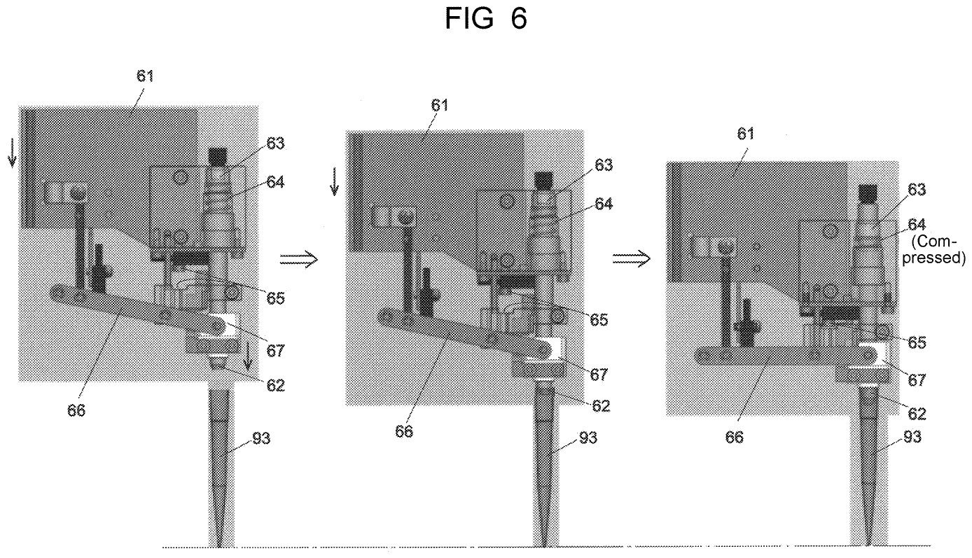

The probe 62 allows the pipette tip 93 to be attached thereto by inserting its lower end into an attached portion which is an opening of the pipette tip 93 (see FIG. 6), and has a gas delivery port that aspirates gas in the attached pipette tip 93 and delivers gas into the pipette tip 93. The probe 62 is held by the movable bar 66 so as to be vertically movable with respect to the elevating unit 61.

The biasing member holding unit 63 is provided on the upper side of the probe 62 and is fixed to the elevating unit 61. The biasing member 64 is composed of an elastic member provided between the probe 62 and the biasing member holding unit 63, and biases the probe 62 downward so as to move away from the biasing member holding unit 63 by extending. In this embodiment, a coil spring is used for the biasing member 64, but other springs or elastic members other than springs may be used.

The sensor 65 is composed of a combination of a detection unit 651 fixed to the elevating unit 61 and a detected unit 652 fixed to the probe 62 via the probe fixture 67. The detection unit 651 detects that the distance to the detected unit 652 has become equal to or less than a predetermined value (e.g., 0, that is, a state of contact with the detected unit 652) and transmits a detection signal.

The pipette tip height calculation unit 68 is a part of the functional blocks included in the control/information processing unit 20. Note that although only the pipette tip height calculation unit 68 is shown among the functional blocks included in the control/information processing unit 20 in FIG. 5, in reality, the control/information processing unit 20 has the functional blocks shown in FIG. 1 or FIG. 4 in addition to the pipette tip height calculation unit 68. The pipette tip height calculation unit 68 acquires, from the robot arm control unit 26, a distance that the elevating unit 61 has descended during a period from when the elevating unit 61 starts descending until the detection signal from the sensor 65 is received, and calculates the height of the lower end of the pipette tip 93 attached to the probe 62 based on the distance. The principle of calculating the height will be described later together with the operation of the pipette tip tip height detection mechanism 60.

### (3-2) Operation of Pipette Tip Tip Height Detection Mechanism 60

The operation of the pipette tip tip height detection mechanism 60 will be described with reference to FIG. 6. In a state where the pipette tip 93 is not attached to the probe 62, the robot arm 16 moves the elevating unit 61 directly above the unused pipette tip holding unit 14 (left diagram in FIG. 6), and then lowers the elevating unit 61. After the probe 62 descends to the height of the attached portion of the pipette tip 93, initially, the probe 62 enters into the attached portion while the biasing member 64 remains extended (middle diagram in FIG. 6). When the elevating unit 61 is further lowered, the biasing member 64 is gradually compressed, and the biasing force applied from the biasing member 64 to the probe 62 increases. Thereby, the probe 62 is inserted deeper into the attached portion. Then, when the elevating unit 61 descends until the sensor 65 enters a detection state and transmits a detection signal (right diagram in FIG. 6), a biasing force having a predetermined magnitude is applied to the pipette tip 93. Thereafter, the elevating unit 61 is raised. By the above operation, the pipette tip 93 is attached to the probe 62 with a biasing force having a predetermined magnitude.

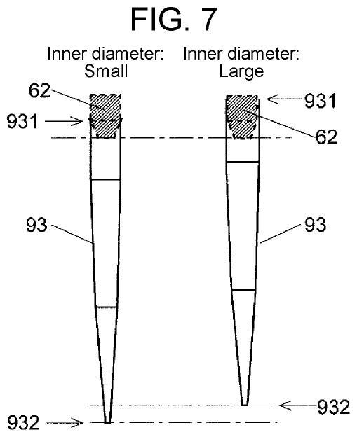

The inner diameters of the attached portions of individual pipette tips 93 differ within the range of tolerance. Therefore, even if the pipette tip 93 is attached to the probe 62 with the same magnitude of biasing force, the larger the inner diameter of the attached portion, the easier it is for the probe 62 to be inserted deeply from an upper end 931 of the pipette tip 93. As a result, when based on the height of the probe 62, the height of a lower end 932 of the pipette tip 93, that is, the suction and discharge port for sucking and discharging liquid, differs for each individual pipette tip 93 (see FIG. 7. In the figure, the height of the probe 62 is shown aligned). If an attempt is made to fractionate liquid from the liquid container 91 without correcting the difference in height of the lower end 932, there is a risk that gas will be aspirated even though the lower end 932 has not actually reached the liquid surface in the liquid container 91, making it impossible to fractionate the liquid sample correctly, or that the lower end 932 will be accidentally made to collide with the bottom of the liquid container 91.

Therefore, the pipette tip height calculation unit 68 acquires, from the robot arm control unit 26, the distance that the elevating unit 61 was lowered until the sensor 65 entered the detection state, and calculates the height of the lower end 932 of the attached pipette tip 93 based on the distance. Specifically, a reference distance, which is a distance the elevating unit 61 descends when the pipette tip 93 is attached to the probe such that the lower end 932 is located at a predetermined reference height, is determined in advance by preliminary experiment. Then, when the pipette tip 93 is actually attached, a distance difference (with positive/negative distinction), which is a distance obtained by subtracting the reference distance from the movement distance of the elevating unit 61, is determined, and by adding the distance difference to the reference height, the position of the lower end 932 after attachment of that pipette tip 93 can be determined.

Note that the aforementioned preliminary experiment may be performed by arranging a positioning member imitating the shape of the attached portion of the pipette tip 93 at a predetermined height instead of the pipette tip 93 itself.

Although the embodiments of the dispensing device according to the present invention have been described above, it goes without saying that the present invention is not limited to the above embodiments and various modifications are possible.

### Aspects

It will be apparent to those skilled in the art that the exemplary embodiments described above are specific examples of the following aspects.
(Item 1) A liquid management device according to one aspect of the present invention comprises:
a placement unit on which a liquid container is placed;
a weight sensor that measures a weight of the placement unit;
a weight measurement value acquisition unit that continuously acquires a measurement value of the weight sensor; and
a zero-point correction execution unit that executes zero-point correction of the weight sensor based on a plurality of measurement values acquired by the weight measurement value acquisition unit between a first time point that is a first predetermined time prior to a load-exceeding measurement value acquisition time point, which is a time point at which the measurement value acquired by the weight measurement value acquisition unit exceeded a predetermined threshold, and a second time point that is a second predetermined time prior to the first time point.

In the liquid management device according to Item 1, the measurement value of the weight sensor acquired in the weight measurement value acquisition unit rises due to the liquid container being placed on the placement unit, and based on the load-exceeding measurement value acquisition time point, which is the time point at which the measurement value exceeded the predetermined threshold, the zero-point correction execution unit executes zero-point correction of the weight sensor based on a plurality of measurement values acquired between the first time point and the second time point which are prior thereto. Further, measurement values acquired between the first time point and the load-exceeding measurement value acquisition time point are excluded from the measurement values used for zero-point correction. The first predetermined time corresponds to a period during which the placement unit is in an unstable state from when the user starts the operation of placing the liquid container on the placement unit until the placement operation is completed. By not using the measurement values of the weight sensor measured during such a period for the zero-point correction processing, the zero-point correction of the weight sensor can be executed accurately. As described above, in the dispensing device according to the present invention, zero-point correction can be performed reliably and accurately without operation by the user, so there is no occurrence of measuring the weight of the liquid container in a state where the zero point is shifted.
(Item 2) The liquid management device according to Item 2 is the device according to Item 1, wherein the zero-point correction execution unit calculates an average value of the plurality of measurement values that are targets of correction processing as a measurement value of the weight sensor at a zero point.

According to the liquid management device according to Item 2, highly valid zero-point correction can be performed by calculating the measurement value of the weight sensor at the zero point using the average value of the plurality of measurement values that are targets of correction processing.

Note that in the liquid management device according to Item 1, a median value or the like may be used instead of the average value of measurement values to be corrected used in the liquid management device according to Item 2.
(Item 3) The liquid management device according to Item 3 is the device according to Item 1 or 2, further comprising:
a liquid weight initial value calculation unit that calculates a liquid weight initial value, which is an initial value of a weight of liquid accommodated in the liquid container placed on the placement unit, based on a measurement initial value, which is a measurement value acquired by the weight measurement value acquisition unit after the load-exceeding measurement value acquisition time point and before a first dispensing is executed, and information on a weight of an empty liquid container; and
a liquid remaining amount calculation unit that calculates a remaining amount of liquid in the liquid container based on the liquid weight initial value, information on a weight of liquid dispensed from the liquid container by one dispensing, and information on the number of times dispensing has been executed from the liquid container.

According to the liquid management device according to Item 3, since the remaining amount of liquid in the liquid container placed on the placement unit can be grasped, the user can replenish the liquid in the liquid container at an appropriate timing.

For the information on the weight of an empty (state where no liquid is stored) liquid container, for example, the user may input it after providing an input device such as a keyboard in the dispensing device, or a value obtained by the weight sensor by placing an empty liquid container on the placement unit in advance may be used. For the information on the weight of liquid dispensed by one dispensing, for example, a value input by the user with the input device or a value preset in hardware or software of the dispensing device can be used.
(Item 4) A dispensing device according to Item 4 comprises:
the liquid management device according to any one of Items 1 to 3;
an elevating unit that moves up and down above a pipette tip holding unit that holds unused pipette tips with attached portions facing upward;
a probe held vertically movably with respect to the elevating unit, to a lower end of which the attached portion of the pipette tip is attached;
a biasing member holding unit provided above the probe and fixed to the elevating unit;
a biasing member provided between the probe and the biasing member holding unit, that biases the probe downward;
a sensor that transmits a detection signal when detecting that a distance in a height direction between the elevating unit and the probe has become equal to or less than a predetermined value; and
a pipette tip height calculation unit that calculates a height of a lower end of the pipette tip based on a distance the elevating unit has descended until the sensor transmits the detection signal when attaching the pipette tip to the probe at the pipette tip attachment position.

In the dispensing device according to Item 4, the pipette tip is attached to the attached portion of the probe by lowering the elevating unit from above the pipette tip holding unit. Here, in the process of lowering the elevating unit, after the lower end of the probe reaches the attached portion of the pipette tip, when the probe is further lowered, the lower end of the probe is gradually pushed into the pipette tip by the biasing force of the biasing member. Then, when the sensor detects that the distance in the height direction between the elevating unit and the probe has become equal to or less than the predetermined value, the biasing member is compressed by a predetermined length between the biasing member holding unit fixed to the elevating unit and the probe. Thereby, the pipette tip is attached to the probe with a biasing force having a predetermined magnitude.

There is a tolerance in the inner diameter of the attached portion of the pipette tip. Due to this tolerance, even if the probe is pushed into the attached portion with a biasing force of a predetermined magnitude, the length that the probe enters into the pipette tip becomes longer as the inner diameter of the attached portion is larger. As a result, the height of the lower end of the pipette tip attached to the probe also changes depending on the inner diameter of the attached portion, and there is a risk that the lower end of the pipette tip cannot be arranged at the correct height when dispensing liquid from the liquid container. Therefore, in the dispensing device according to Item 4, the pipette tip height calculation unit calculates the height of the lower end of the pipette tip based on the distance that the movement mechanism lowered the probe until the maximum biasing force having the predetermined magnitude was applied. Based on the calculated height of the lower end of the pipette tip, the lower end of the pipette tip can be arranged at the correct height during dispensing.

### REFERENCE SIGNS LIST

1, 2 . . . Dispensing device
5, 6 . . . Liquid management device
11 . . . Placement unit
12 . . . Weight sensor
13 . . . Specimen container holding unit
14 . . . Unused pipette tip holding unit
141 . . . Used pipette tip storage container
15 . . . Post-reagent-addition specimen processing unit
16 . . . Robot arm
161 . . . Gripping unit
162 . . . Planar movement mechanism
17 . . . Liquid reagent aspiration and discharge mechanism
20 . . . Control/information processing unit
21 . . . Weight measurement value acquisition unit
22 . . . Zero-point correction execution unit
23 . . . Weight measurement value display processing unit
24 . . . Reagent remaining amount warning notification unit
25 . . . Aspiration and discharge mechanism control unit
26 . . . Robot arm control unit
27 . . . Post-reagent-addition processing control unit
28 . . . Sample remaining amount initial value calculation unit
29 . . . Reagent remaining amount calculation unit
30 . . . Storage unit
40 . . . Input unit
50 . . . Display unit
60 . . . Pipette tip tip height detection mechanism
61 . . . Elevating unit
62 . . . Probe
63 . . . Biasing member holding unit
64 . . . Biasing member
65 . . . Sensor
651 . . . Detection unit
652 . . . Detected unit
66 . . . Movable bar
67 . . . Probe fixture
68 . . . Pipette tip height calculation unit
91 . . . Liquid container
92 . . . Specimen container
93 . . . Pipette tip
931 . . . Upper end of pipette tip
932 . . . Lower end of pipette tip

1. A liquid management device comprising:
a placement unit on which a liquid container is placed;
a weight sensor that measures a weight of the placement unit;
a weight measurement value acquisition unit that continuously acquires a measurement value of the weight sensor; and
a zero-point correction execution unit that executes zero-point correction of the weight sensor based on a plurality of measurement values acquired by the weight measurement value acquisition unit between a first time point that is a first predetermined time prior to a load-exceeding measurement value acquisition time point, which is a time point at which the measurement value acquired by the weight measurement value acquisition unit exceeded a predetermined threshold, and a second time point that is a second predetermined time prior to the first time point.

2. The liquid management device according to claim 1, wherein the zero-point correction execution unit calculates an average value of the plurality of measurement values that are targets of correction processing as a measurement value of the weight sensor at a zero point.

3. The liquid management device according to claim 1, further comprising:
a liquid weight initial value calculation unit that calculates a liquid weight initial value, which is an initial value of a weight of liquid accommodated in the liquid container placed on the placement unit, based on a measurement initial value, which is a measurement value acquired by the weight measurement value acquisition unit after the load-exceeding measurement value acquisition time point and before a first dispensing is executed, and information on a weight of an empty liquid container; and
a liquid remaining amount calculation unit that calculates a remaining amount of liquid in the liquid container based on the liquid weight initial value, information on a weight of liquid dispensed from the liquid container by one dispensing, and information on the number of times dispensing has been executed from the liquid container.

4. A dispensing device comprising:
the liquid management device according to claim 1;
an elevating unit that moves up and down above a pipette tip holding unit that holds unused pipette tips with attached portions facing upward;
a probe held vertically movably with respect to the elevating unit, to a lower end of which the attached portion of the pipette tip is attached;
a biasing member holding unit provided above the probe and fixed to the elevating unit;
a biasing member provided between the probe and the biasing member holding unit, that biases the probe downward;
a sensor that transmits a detection signal when detecting that a distance in a height direction between the elevating unit and the probe has become equal to or less than a predetermined value; and
a pipette tip height calculation unit that calculates a height of a lower end of the pipette tip based on a distance the elevating unit has descended until the sensor transmits the detection signal when attaching the pipette tip to the probe at the pipette tip attachment position.
